(19) United States
(12) Patent Application Publication
(10) Pub. No.: US 2005/0134641 A1
(43) Pub. Date: Jun. 23, 2005

(54) Ink jet recording method and apparatus thereof

(75) Inventor: Yoshihide Hoshino, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 10/968,301

(22) Filed: Oct. 20, 2004

(30) Foreign Application Priority Data
Oct. 23, 2003 (JP) JP2003-363489

(51) Int. Cl. G06K 1/00

(52) U.S. Cl. 347/43

(57) ABSTRACT

An ink jet recording apparatus for expressing various colors by combinations of fundamental colors, the apparatus includes: a recording head for ejecting inks; ink tanks for storing inks of two or more different densities for each colors; a section that judges whether the pixel is a single color component pixel or a multiple color component pixel; and a control section for selecting an ink to be ejected and for controlling a quantity of the ink ejected, such that the multiple color component pixels, at least an ink of one color corresponding to one of color components of the multiple color component pixel and being landed on a multiple color component pixel has higher density and smaller quantity than an ink of said one color corresponding to a color component of a single color component pixel and being landed on the single color component pixel.

### BACKGROUND OF THE INVENTION

The present invention relates to ink jet recording apparatuses.

Conventionally, in the field of printing on packing materials, the gravure printing method and the flexo-graphic printing method are being used widely.

Since a plate making process is necessary in the gravure printing method as well as in the flexo-graphic printing method, they have a disadvantage in the cost aspect when carrying out small-lot printing.

On the other hand, the inkjet recording method which lands the ink at all times in the desired position is used with advantage in small lot production because it does not contain a plate making process.

In particular, since the printing is possible on various types of recording media in the ink jet recording method using ultraviolet ray hardening type ink, its applicability is also high in the field of printing on packaging materials. Conventionally, ink jet recording apparatuses have been realized using radical polymerization type inks and irradiation with substantial amount of ultraviolet rays (Patent reference document 1).

However, further improvements in the recording image quality are required in order to increase the demand for ink jet recording methods.

For example, in the ink jet recording method using water-based inks or oil-based inks, although most of the ink gets absorbed by and fixed in the recording medium, even if a special recording paper is used, the ink overflows and the recording quality is lost when the amount of ink landing on the recording paper exceeds the acceptance limit of the recording paper.

Furthermore, in the ink jet recording method using ultraviolet ray hardening inks, the ink remaining on the surface of the recording medium gets hardened, and it is considered that the ink in the landing position gets hardened in a mound shape when viewed in the micro scale, as a result of which phenomena such as sandiness, undulations, or excessive shininess of the image occur thus lowering the recorded image quality. Such phenomena are particularly marked in recording areas where large quantities of ink are made to land.

In addition, these phenomena are not only more significant in secondary and ternary colors that are expressed by combinations of two or more fundamental colors than in primary colors that are expressed by only one color among the fundamental colors (for example, cyan, magenta, yellow, and black), but also the difference in quality between the primary colors and the secondary or ternary colors becomes noticeable thereby lowering the recorded image quality.

[Patent reference document 1: Japanese patent application laid open No. 2001-310454]

[Patent reference document 1: Japanese patent registration No. 3363773]

In order to solve above problem of lowering of the recorded image quality, the technology of reducing the quantity of each color in proportion to their ratios when the quantity of ink per unit area reaches a specific value is being used widely (Patent reference document 2).

In said technology, while reduction in the clarity of the recorded image is feared, it was not possible to eliminate or reduce the above mentioned difference between areas recorded using primary colors and areas recorded using secondary and ternary colors in terms of sandiness, undulations, and shininess of the recorded image, and the improvement in the recorded image quality was not sufficient.

The present invention was made with the above problems in the conventional technology in view, and is intended to suppress reduction in the recorded image quality due to the landing of excessive amounts of ink and to improve the recorded image quality.

### SUMMARY OF THE INVENTION

One aspect of the ink jet recording apparatus according to the present invention for solving the above problems has the following configuration.

(1) An ink jet recording apparatus for expressing various colors by combinations of plural fundamental colors, the ink jet recording apparatus comprising: a recording head for individually ejecting inks of plural fundamental colors; a plurality of ink tanks for storing inks of two or more different densities for each of plural fundamental colors; a pixel color component discrimination section that judges for each pixel whether the pixel is a single color component pixel having only one color component among the plural fundamental colors or multiple color component pixel having two or more color components among the fundamental colors; and a recording head drive control section for selecting an ink to be ejected from the recording head among the inks of two or more different densities and for controlling a quantity of the ink ejected by the recording head, based on a judgment result of the pixel color component discrimination section, such that, for all or part of the multiple color component pixels, at least an ink of one color corresponding to one of color components of the multiple color component pixel and being landed on a multiple color component pixel has higher density and smaller quantity than an ink of said one color corresponding to a color component of a single color component pixel and being landed on the single color component pixel.

Therefore, according to the configuration of (1) above, ink of at least one color among the inks in the area corresponding to multiple color component pixels in the recording medium becomes higher in density and smaller in quantity than the ink in the area corresponding to single color component pixels on the recording medium. As a consequence, when compared to the case in which each of the inks in the area corresponding to multiple color component pixels on the recording medium are of the same quantity as that of the ink in the area corresponding to single color component pixels on the recording medium, the difference between the total quantity of ink on the recording medium in the area corresponding to multiple color component pixels and the total quantity of ink on the recording medium in the area corresponding to single color component pixels becomes small.

Therefore, the difference in the quantities of inks becomes small between the area corresponding to single color component pixels on the recording medium, that is, the area recorded using one of the above mentioned primary colors, and the area corresponding to multiple color component pixels on the recording medium, that is, the area recorded using the above mentioned secondary and ternary colors, and thus it becomes possible to suppress the lowering of recorded image quality due to excessive quantity of ink and to improve the quality of the recorded image.

### BRIEF DESCRIPTION OF THE DRAWINGS

FIG. 1: This figure is the block diagram of the important parts of an ink jet recording apparatus according to a preferred embodiment of the present invention.

FIGS. 2(a)-2(c): These are figures showing one example of a pixel matrix.

FIGS. 3(a)-3(c): These are figures showing another example of a pixel matrix.

### DETAILED DESCRIPTION OF THE PREFERRED EMBODIMENT

The abovementioned problems can be also solved by the following configurations.

(2) The ink jet recording apparatus according to configuration (1), further comprising: a colorless surrounding pixel discrimination section for discriminating a colorless surrounding pixel, which is a pixel surrounding the multiple color component pixel and having no color component;
wherein the recording head drive control section, based on discriminating result of the colorless surrounding pixel discrimination section, with respect to one specific multiple color component pixel having the colorless surrounding pixel, controls not to land the ink corresponding to one of the color components of the multiple color component pixel or the inks corresponding to two or more but one less than a number of color components in the multiple color component pixel onto the one specific multiple color component pixel, but controls to land the ink or the inks, by each one color component, onto the colorless surrounding pixel.

According to configuration (2), for multiple color component pixels having no colorless surrounding pixels, similar to the configuration described in (1) above, the ink of at least one of the color components in the area corresponding to the multiple color component pixel on the recording medium has higher density and lower quantity than the ink in the area corresponding to single color component pixels on the recording medium. Because of this, when compared to the case in which each of the inks in the area corresponding to multiple color component pixels on the recording medium is of the same quantity as the ink in the area corresponding to single color component pixels on the recording medium, the difference becomes small between the total quantity of ink in the area corresponding to a multiple color component pixel on the recording medium and the total quantity of ink in the area corresponding to a single color component pixel on the recording medium.

Furthermore, according to the configuration described in (2) above, for multiple color component pixels having colorless surrounding pixels, the number of ink colors gets reduced in the area corresponding to multiple color component pixels on the recording medium, and difference becomes small between the total quantity of ink in the area corresponding to a multiple color component pixel on the recording medium and the total quantity of ink in the area corresponding to a single color component pixel on the recording medium. On the other hand, since ink of one color component each is landed in the case of colorless surrounding pixels, the quantity of ink will not become excessive and on the whole local concentration of ink gets reduced.

Therefore, the difference in the quantities of inks becomes small between the area corresponding to single color component pixels on the recording medium, that is, the area recorded using the above mentioned primary colors, and the area corresponding to multiple color component pixels on the recording medium, that is, the area recorded using the above mentioned secondary and ternary colors, and thus it becomes possible to suppress the lowering of recorded image quality due to excessive quantity of ink and to improve the quality of the recorded image.

(3) The ink jet recording apparatus according to configuration (2), wherein colorless surrounding pixel discrimination section judges whether or not each of pixels in a series-of pixels including two or more pixels, which are adjacent to one of the multiple color component pixel and are arranged in a direction going away from said one of the multiple color component pixel, is a colorless surrounding pixel of said one multiple color component pixel, and when all pixels in the series of pixels are judged to be the colorless surrounding pixel, the recording head drive control section selects, the furthest pixel in the series of pixels from said one multiple color component pixel as the colorless surrounding pixel onto which ink being landed.

According to configuration (3), as the area corresponding to the colorless surrounding pixel in which ink is landed becomes farther away from the area corresponding to the multiple color component pixel on the recording medium, it becomes possible to reduce the local concentration of ink in a more advanced manner, and hence it is possible to suppress the reduction in the recorded image quality due to excessive quantity of ink and to increase the effect of improving the recorded image quality.

(4) The ink jet recording apparatus according to configuration (2), wherein the recording head drive control section, controls not to land the inks corresponding to a number of colors one less than a number of color components in one of the multiple color component pixel having the colorless surrounding pixel onto said one of the multiple color component pixel, but controls to land the inks, by each color component, onto the colorless surrounding pixel.

According to configuration (4), even when the pixel is a multiple color component pixel having three or more color components, the ink landed on the area corresponding to that multiple color component pixel on the recording medium will only be of one color, and hence the local concentration of ink will be reduced to the same level as that of a multiple color component pixel with two color components.

(5) The ink jet recording apparatus according to any one of configuration (1) to configuration (4) above with the feature that said ink is an ink that gets hardened when it is irradiated with an energy radiation, and the configuration of the apparatus includes a device for irradiating the ink that has landed on the recording medium with energy radiation.

According to configuration (5), in an ink jet recording method of the type of hardening the ink by irradiating it with energy radiation such as light, or electron beam, etc., it is possible to suppress the reduction in image quality such as sandiness, undulations, shininess, etc., and also suppressing imbalance in appearance of quality between primary colors and secondary or ternary colors, and hence to improve the picture quality.

(6) An ink jet recording method for expressing various colors by combinations of plural fundamental colors, by ejecting inks of plural fundamental colors with plural different densities from a recording head onto a recording medium, the ink jet recording method comprising: judging, for each pixel, whether the pixel is a single color component pixel having only one color component among the plural fundamental colors or multiple color component pixel having two or more color components among the fundamental colors; and selecting an ink to be ejected from the recording head among the inks with plural different densities and controlling a quantity of the ink ejected by the recording head, based on a result of the judging step, such that, for all or part of the multiple color component pixels, at least an ink of one color corresponding to one of color components of the multiple color component pixel and being landed on a multiple color component pixel has higher density and smaller quantity than an ink of said one color corresponding to a color component of a single color component pixel and being landed on the single color component pixel.

As has been described above, according to the present invention, the difference in the quantity of ink becomes small between the area corresponding to single color component pixels on the recording medium, that is, the area that has been recorded using a primary color described above, and the area corresponding to multiple color component pixels on the recording medium, that is, the area that has been recorded using a secondary or a ternary color described above, and hence it becomes possible to suppress the recorded image quality due to excessive quantities of ink, and thereby to improve the recorded image quality.

When using water-based or oil-based inks, there is the effect of suppressing reductions in recorded image quality such as blotchiness due to excessive quantity of ink, and thus, of improving the recorded image quality.

When using special inks that get hardened when irradiated with energy radiation such as light or an electron beam, particularly, there are significant effects of suppressing reductions in image quality such as sandiness, undulations, shininess, etc., and also of suppressing imbalance in appearance of quality between primary colors and secondary or ternary colors, and hence improving the picture quality.

### PREFERRED EMBODIMENT

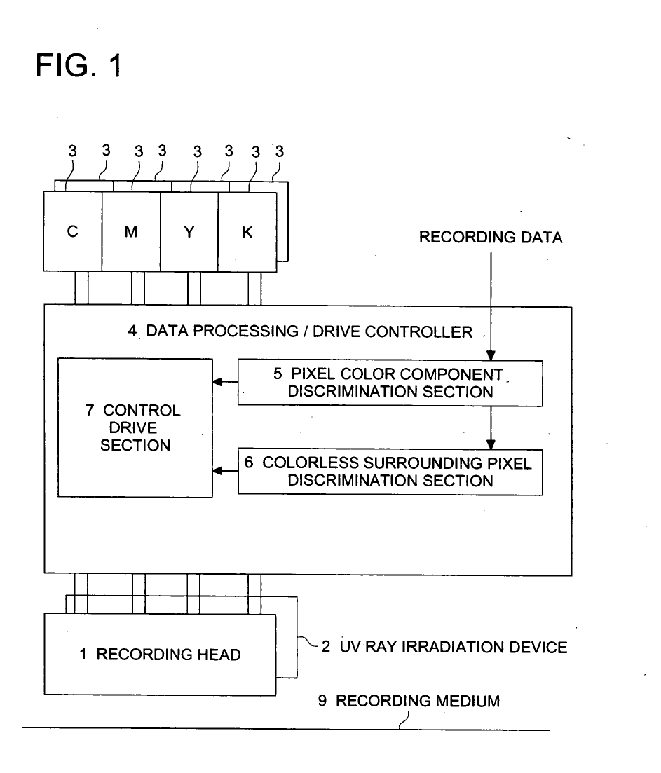

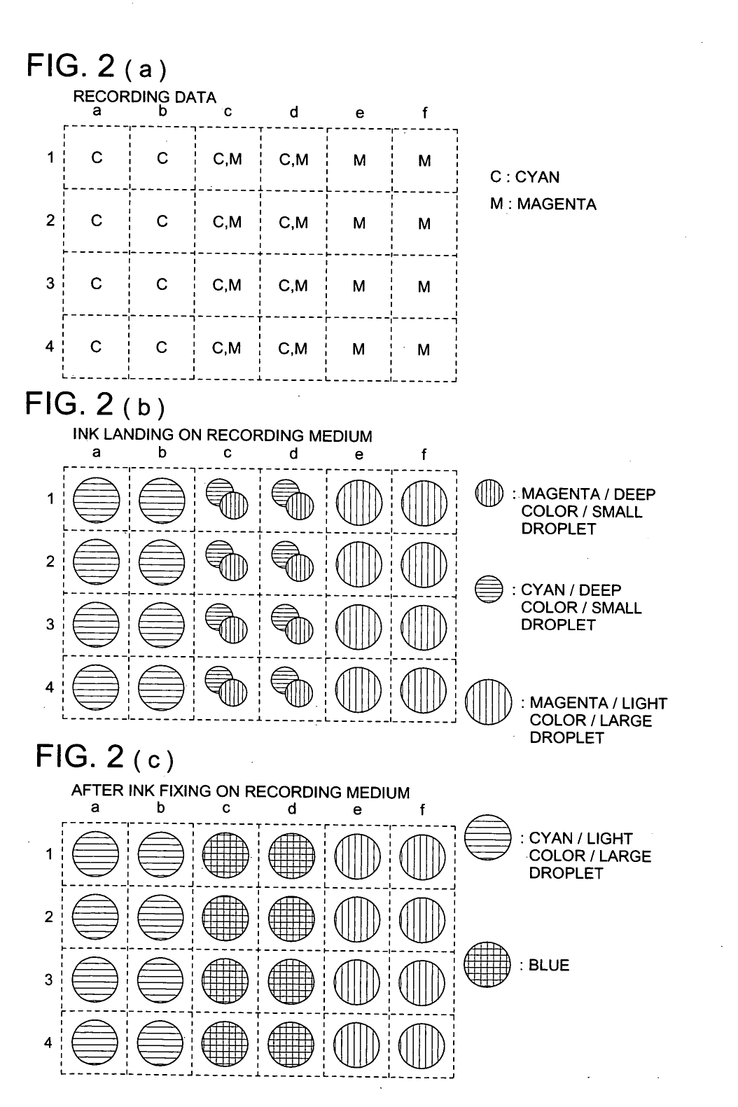

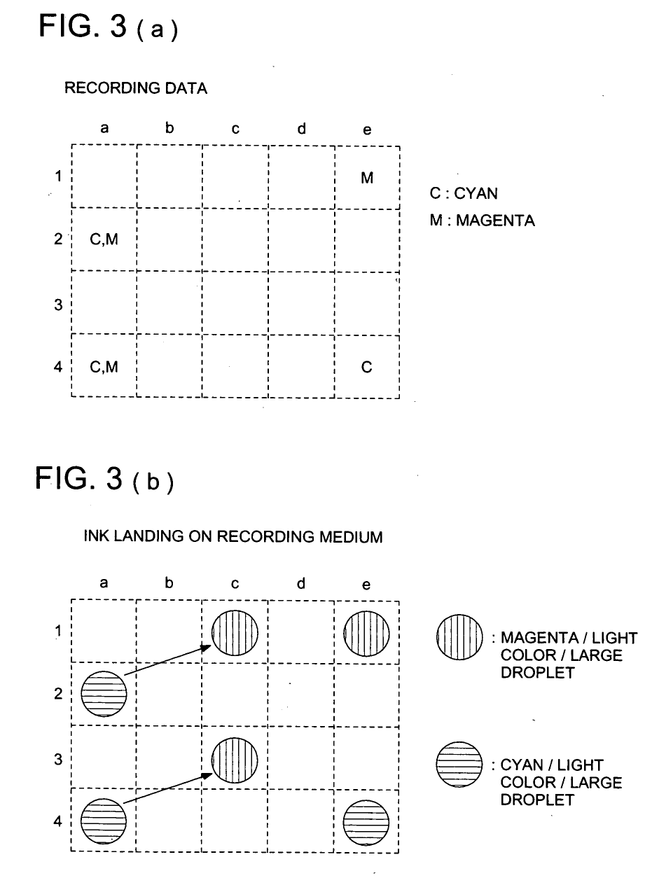

A preferred embodiment of the present invention is described below referring to the drawings. The following is merely one preferred embodiment of the present invention and the descriptions given here are not to be construed to limit the scope and intent of the present invention in any manner. FIG. 1 shows the block diagram of the important parts of an ink jet recording apparatus according to the present invention. FIGS. 2(a)-2(c) and FIGS. 3(a)-3(c) are drawings showing two examples of pixel matrices.

As is shown in FIG. 1, the ink jet recording apparatus according to the present preferred embodiment of the present invention is configured using the ink jet head 1, the ultraviolet ray irradiation apparatus 2, the ink tank 3, and the data processing and drive control apparatus 4.

Although the ink jet head 1 used is a hitherto known recording head of the ink jet method that ejects inks from plural ejection nozzles, in order to implement the present invention, we have used in the present-preferred embodiment an ink jet head that is capable of ejecting small droplets and large droplets.

The inks used in the present preferred embodiment are of the ultraviolet ray hardening type, and inks of the four colors cyan (C), magenta (M), yellow (Y), and black (B) are used as the fundamental colors with two densities of inks of each color being used, making a total of 8 types of ink being used in the present preferred embodiment. These 8 types of ink are respectively stored in eight ink tanks 3. Each of these ink tanks 3 is connected to-the ink jet head 1 by a mutually independent and separate supply path. For example, eight units of the ink jet head 1 are provided corresponding to the eight ink tanks.

Each ink supplied from each ink tank 3 is individually selected and is ejected from the ink jet head 1 under the control of the data processing and drive control section 4.

In addition to the above configuration, commonly known scanning means for the ink jet heads 1 and transport means for the recording medium 9 are provided thereby making the ink droplets land on the recording medium 9 at the desired locations.

The ultraviolet ray irradiation apparatus 2 is configured using semiconductor laser diodes or light emitting diodes (LEDs) as the light source emitting the ultraviolet rays for hardening the ink that is ejected from the ink jet head 1 and is adhered on the recording medium 9. It is also possible to use a fluorescent lamp as the light source.

The data processing and drive control apparatus 4 is configured using hitherto known technologies of a computer and programs running on a computer, but the hardware configuration such as ICs and analog circuits can be anything. The data processing and drive control apparatus 4 contains a pixel color component discrimination section 5, a colorless surrounding pixel discrimination section 6, and a drive control section 7. However, it is not necessary to adhere to the names of these constituent parts or their division into blocks, and the present invention can be implemented if their functions are configured in effect.

The pixel color component discrimination section 5 carries out judgment, for each pixel of the recording data that has been input, of whether each pixel is a pixel having only one fundamental color as its sole color component (referred-to as a “single color component pixel”) or a pixel having two or more fundamental colors as-its color components (referred to as a “multiple color component pixel”), and outputs a signal indicating the result of this judgment to the colorless surrounding pixel discrimination section 6 and the drive control section 7.

The colorless surrounding pixel discrimination section 6 carries out judgment, for the recording data that has been input and based on the result of judgment in the pixel color component discrimination section 5, whether or not there is a pixel with no color component (called a colorless surrounding pixel) surrounding a specific multiple color component pixel, and outputs a signal indicating the result of this judgment to the drive control section 7.

The drive control section 7 carries out, based on the recording data, and the judgment results from the pixel color component discrimination section 5 and the colorless surrounding pixel discrimination section 6 that have been input, control of the selection of the timing of ink ejection from the ink jet head 1, selection of the ink ejection nozzle from which the ink has to be ejected, and the quantity of ink to be ejected. In this manner, the ink jet recording apparatus according to the present preferred embodiment of the present invention writes images with color rendering on the recording medium 9 using combinations of fundamental colors (C, M, Y, and K).

Next, explanation is given here about the recording data. The recording data is constituted using binary signal values of whether or not each of the color components C, M, Y, and K are to be the color components for each pixel.

FIG. 2(a) and FIG. 3(a) show diagrammatically samples of recording data. FIG. 2(a) is a 4×6 pixel matrix, and for example, pixel (1, a) indicates that cyan (C) has been made the color component. Pixel (2, c) indicates that cyan (C) and magenta (M) have been made the color components. Pixel (3, e) indicates that magenta (M) has been made the color component.

FIG. 3(a) is a 4×5 pixel matrix, and for example, pixel (1, a) indicates that it has no color component. Pixel (2, a) indicates that cyan (C) and magenta (M) have been made the color components. Pixel (4, e) indicates that its color component is cyan (C).

Next, explanation will be given of an example of operation of the ink jet recording apparatus according to the present preferred embodiment in the sequence of the flow of operations.

Consider that the data processing and drive control apparatus 4 receives instruction to give recorded output of the recording data indicated in FIG. 2(a).

Whereupon, the data processing and drive control apparatus reads in the recording data.

Next, the pixel color component discrimination section 5 makes the judgment for each pixel whether it is a single color component pixel or a multiple color component pixel. The pixel color component discrimination section 5 generates a signal indicating that the pixels (1, a), (1, b), (1, e), (1, f), (2, a), (2, b), (2, e)., (2, f), (3, a), (3, b), (3, e), (3, f), (4, a), (4, b), (4, e), and (4, f) are single color component pixels and the pixels (1, c), (1, d), (2, c), (2, d), (3, c), (3, d), (4, c), and (4, d) are multiple color component pixels, and outputs this signal to the colorless surrounding pixel discrimination section 6 and to the drive control section 7.

Next, the colorless surrounding pixel discrimination section 6 makes the judgment for every multiple color component pixel whether there are any colorless surrounding pixels for that pixel. The colorless surrounding pixel discrimination section 6 makes this judgment for all the pixels that have been judged by the pixel color component discrimination section 5 to be multiple color component pixels. The colorless surrounding pixel discrimination section 6 generates a signal as the result of judgment for the pixels (1, c), (1, d), (2, c), (2, d), (3, c), (3, d), (4, c), and (4, d) indicating that there are no colorless surrounding pixels for each of these pixels and outputs that signal to the drive control section 7.

The drive control section 7, upon receiving the judgment result of the pixel color component discrimination section 5 and the judgment result of the colorless surrounding pixel discrimination section 6, determines as follows the density and the quantity of the inks to be ejected on to the areas corresponding to the pixels on the recording medium, and controls the operation of the ink jet head 1.

As is shown in FIG. 2(b), large droplets of light colored cyan ink is ejected for the cyan single color component pixels (1, a), (1, b), (2, a), (2, b), (3, a), (3, b), (4, a), and (4, b).

Large droplets of light colored magenta ink is ejected for the magenta single color component pixels (1, e), (1, f), (2, e), (2, f), (3, e), (3, f), (4, e), and (4, f).

Small droplets of dark colored cyan ink and small droplets of dark colored magenta ink are ejected for the cyan-magenta multiple color component pixels (1, c), (1, d), (2, c), (2, d), (3, c), (3, d), (4, c), and (4, d).

With the above operations, the formation of image is completed with the image after the inks are deposited on the recording medium being as is shown in FIG. 2(b). As is shown in FIG. 2(c), after dispersion of the ink and after its hardening by ultraviolet rays, the color image with the three colors cyan, blue, and magenta gets fixed on the recording medium 9.

In the above manner, the quantity of cyan ink and the quantity of magenta ink in multiple color component pixels are made smaller compared to the quantities in respective single color component pixels.

If, for example, the quantities of the inks in multiple color component pixels are made the same as the quantities of the inks in single color component pixels, the quantity of ink in a multiple color component pixel would become excessive being twice the quantity of ink in a single color component pixel, which would cause reductions in the perceptible image quality such as sandiness, undulations, and shininess, etc., and also cause imbalance in the perceived quality of image between primary color images and secondary or ternary color images.

However, according to the present preferred embodiment, since the quantity of cyan ink and the quantity of magenta ink in multiple color component pixels have respectively been made smaller than the quantities in their single color component pixels, the quantities of inks in multiple color component pixels do not become excessive, and the difference between their quantities and the quantities in single color component pixels also becomes small, thereby suppressing the reductions in the perceptible image quality such as sandiness, undulations, and shininess, etc., and also suppressing the imbalance in the perceived quality of image between primary color images and secondary or ternary color images. In addition, because the quantity of ink becomes smaller, and since denser ink is used, the perceived intensity of blue color can be expressed without any degradation.

Useful effect can be obtained in a multiple color component pixel if the quantity of the ink of at least one of the colors of cyan and magenta is made smaller than the respective quantity in a single color component pixel.

The same is also valid in the case of a multiple color component pixel having the colors of cyan, magenta, and yellow, and the quantity of ink is made smaller than in a single color component pixel in at least one of these colors.

Next, the operations are described below when the data processing and drive control apparatus 4 receives the instruction for making the recording output of the recording data shown in FIG. 3(a).

The data processing and drive control apparatus 4 receives the instruction for making the recording output of the recording data shown in FIG. 3(a). Thereupon, the data processing and drive control apparatus 4 reads in the recording data.

Next, the pixel color component discrimination section 5 makes the judgment for each pixel whether it is a multiple color component pixel or a single color component pixel. The pixel color component discrimination section 5, generates, as the result of the judgment, a signal indicating that pixels (1, e) and (4, c) are single color component pixels and the pixels (2, a) and (4, a) are multiple color component pixels, and outputs this signal to the colorless surrounding pixel discrimination section 6 and the data processing and drive control section 7.

Next, the colorless surrounding pixel discrimination section 6 makes the judgment for every multiple color component pixel whether or not there are any colorless surrounding pixels for that pixel. The colorless surrounding pixel discrimination section 6 makes this judgment for all the pixels that have been judged by the pixel color component discrimination section 5 to be multiple color component pixels.

The colorless surrounding pixel discrimination section 6 judges whether each of the pixels contained in the sequence of pixels containing two or more pixels arranged in a direction going away from each specific multiple color component pixel is or is not a colorless surrounding pixel of that specific multiple color component pixel. For example, the two pixels (2, b) and (2, c) that are going away from the, multiple color component pixel (2, a) in the upward right direction in the figure, or the two pixels (2, b) and (1, c) that are going away in the diagonal upward direction, or the pixels (1, a), (1, b), (1, c), (2, b), and (2, c) that include the pixels (1, b) and (1, c) are judged to be the colorless surrounding pixels of the multiple color component pixel (2, a).

In a similar manner, the pixels (3, a), (3, b), (3, c), (4, b), and (4, c) are judged to be the colorless surrounding pixels of the multiple color component pixel (4, a).

The colorless surrounding pixel discrimination section 6 generates a signal as the result of judgment that the pixels (1, a), (1, b), (1, c), (2, b), and (2, c) are the colorless surrounding pixels for the pixel (2, a), and that the pixels (3, a), (3, b), (3, c), (4, b), and (4, c) are the colorless surrounding pixels for the pixel (4, a), and outputs that signal to the data processing and drive control section 7.

The drive control section 7, upon receiving the judgment result of the pixel color component discrimination section 5 and the judgment result of the colorless surrounding pixel discrimination section 6, determines as follows the density and the quantity of the inks to be ejected on to the areas corresponding to the pixels on the recording medium 9, and controls the operation of the ink jet head 1.

As is shown in FIG. 3(b), a large droplet of light colored cyan ink is ejected for the cyan single color component pixel (4, e).

A large droplet of light colored magenta ink is ejected for the magenta single color component pixel (1, e). For the cyan-magenta multiple color component pixel (2, a), among its component colors of cyan and magenta, a large droplet of light colored cyan ink is ejected on the area corresponding to that pixel (2, a) itself, and for the other color component of magenta, a large droplet of light colored magenta ink is ejected on the colorless surrounding pixel (1, c) that is farthest from that pixel (2, a) itself.

For the cyan-magenta multiple color component pixel (4, a), among its component colors of cyan and magenta, a large droplet of light colored cyan ink is ejected on the area corresponding to that pixel (4, a) itself, and for the other color component of magenta, a large droplet of light colored magenta ink is ejected on the colorless surrounding pixel (3, c) that is farthest from that pixel (4, a) itself.

With the above operations, the formation of image is completed with the image after the inks are deposited on the recording medium 9 being as is shown in FIG. 3(b).

In the above manner, the ejection of magenta ink in the case of a multiple color component pixel was shifted to a colorless surrounding pixel at the time of magenta ink ejection.

If, for example, the quantities of the inks in multiple color component pixels are made the same as the quantities of the inks in single color component pixels, the quantity of ink in a multiple color component pixel would become excessive being twice the quantity of ink in a single color component pixel which would cause reductions in the perceptible image quality such as sandiness, undulations, and shininess, etc., and also cause imbalance in the perceived quality of image between primary color images and secondary or ternary color images.

However, according to the present preferred embodiment, since the ejection of magenta ink in the case of a multiple color component pixel was shifted to a colorless surrounding pixel at the time of magenta ink ejection, the quantities of inks in multiple color component pixels do not become excessive, and the difference between their quantities and the quantities in single color component pixels also becomes small, thereby suppressing the reductions in the perceptible image quality such as sandiness, undulations, and shininess, etc., and also suppressing the imbalance in the perceived quality of image between primary color images and secondary or ternary color images.

In a similar manner, in the case of a multiple color component pixel having the colors of cyan, magenta, and yellow, the ink ejection is shifted to a colorless surrounding pixel at the time of ejecting the ink of at least one of these colors. When shifting two colors in this manner, the shifting is done to two separate colorless surrounding pixels so that one color each is ejected onto one pixel.

Where n is an integer number equal to or more than 3, for a multiple color component pixel of n colors, the inks corresponding to 2 or more color components but not more than (n−1), that is, 1 less than the number of color components n, are not ejected on their original pixel, but ink of one color each is landed in one of the colorless surrounding pixels. In other words, this shifting of the pixel of ejecting the colors is done so that at least the ink of one color is made to land on the area on the recording medium corresponding to a multiple color component pixel.

For example, it is also possible to print a recording data containing simultaneously the recording data shown in FIG. 2(a) and the recording data shown in FIG. 3(a).

In this case, for multiple color component pixels having colorless surrounding pixels, the color component distribution operation similar to that shown for the recording data of FIG. 3(a) is carried out first on a priority basis, and, for the multiple color component pixels that do not have colorless surrounding pixels, the ink landing is made on the same pixel but with smaller droplets of higher density ink as was done for the recording data shown in FIG. 2(a).

In the above preferred embodiment, although an ink jet head capable of ejecting large and small droplets of ink was adopted, when using an ink jet head that does not allow the selection of the size of the ink droplets, it is possible to carry out the control of the quantity of the ink ejected according to the present invention by varying the number of droplets of the same color landed in each pixel. For example, in the above preferred embodiment, it is possible to implement the invention by taking small droplets as one ink drop in a pixel and large droplets as two ink drops in the same pixel.

Next, the technologies that can be adopted as preferred embodiments of the present invention are described individually below.

Quantity of Ejection:

The quantity of ink ejected per dot is 2 pl (picoliters) to 20 pl. The desirable quantity of ejection is 4 pl to 10 pl. High definition printing becomes difficult when this quantity exceeds 20 pl per dot, and the density of the formed image becomes low when the quantity of ejection is less than 2 pl.

Dot Diameter:

The diameter of a dot formed on the recording medium is 50 μm to 200 μm. It is desirable that the dot diameter is in the range of 50 μm to 150 μm, and more preferably in the range of 55 μm to 100 μm. The density of the formed image becomes low at dot diameters of less than 50 μm, and high definition printing becomes difficult at dot diameters of larger than 200 μm.

Not Containing Water or Organic Solvents:

It is desirable that the ink used effectively does not contain water and organic solvents. “Effectively does not contain” means that the content of water and organic solvents should be less than 1% by weight.

Ink Jet Method:

As the method of driving the ink ejection in an ink jet printer, it is preferable to use the piezoelectric effect of a piezoelectric body that can give high speed ejection and has wide range of applicability towards the ink. In concrete terms, as, for example, has been described in Japanese Patent Disclosure No. Hei 4(1992)-48622, electrode films are formed on the inside of very fine grooves which have been formed on a piezoelectric substrate, and they are further coated with an insulating film to form the ink path in an ink jet head.

Irradiation beam source:

Although it is possible to use a variety of beam sources such as ultraviolet rays, electron beams, X-rays, visible light, infra-red light, etc., when the ink hardening characteristics and cost, etc., are considered, it is desirable to use irradiation with ultraviolet rays. It is possible to use mercury lamps, metal halide lamps, excimer lamps, UV lasers and LEDs, etc., as the ultraviolet ray source.

The basic method of irradiation has been disclosed in Japanese Patent Application Laid Open No. Sho 60(1985)-132767. According to this method, light sources are provided on both sides of the head unit, and the head as well as the light source are scanned in a shuttle manner. The irradiation is done when a specific time interval has elapsed after the ink has been landed on the recording medium. In addition, the hardening is completed by a separate light source that is not driven. In WO No.9954415, other methods of irradiation have been disclosed such as a method using optical fibers, or a method of impinging a collimated light beam on a mirror surface provided on the side of the head unit and irradiating the recording section with UV light. These methods of irradiation can be used as preferred embodiments of the present invention.

In concrete terms, it is desirable to use band shaped metal halogen lamp tubes and UV lamp tubes. It is possible to achieve low cost by keeping the radiation source in effect fixed to the ink jet printer thereby eliminating moving sections.

It is desirable to carry out irradiation of the image formation separately for each color, that is, two types of radiation sources are provided using any type of exposure method, and completing the hardening by the second radiation source is a preferable method. This contributes to obtaining the wetness of the second ejection of ink and the adhesion between inks and also to constructing the radiation source in an economical manner.

Further, it is preferable to change the exposure wavelength or the exposing radiation intensity between the first and the second radiation sources. The irradiation energy of the first radiation source should preferably be made smaller than the irradiation energy of the second radiation source, that is, the irradiation energy of the first radiation source should be 1% to 20% of the total amount of radiation energy of exposure, and should preferably be 1% to 10%, or, even more preferably be 1% to 5%. Because the irradiation is done with different radiation intensities, the molecular weight of the ink after hardening changes to a more desirable value. In other words, if irradiation with a high intensity radiation is done at once, although it is possible to increase the rate of polymerization, the molecular weight of the polymerized molecules will be small and hence it will not be possible to obtain sufficient strength.

Further, by making the radiation from the first radiation source have a shorter wavelength than that of the radiation from the second radiation source, it is possible to make the first irradiation harden the surface layer of the ink thereby suppressing the spreading of the ink, and harden the ink during the second irradiation near the recording medium which location is harder for the radiation to reach, thereby enhancing the closeness of adhesion of the ink to the recording medium. Even for promoting the hardening of the interior of the ink, it is desirable that the wavelength of radiation of the second irradiation be a long wavelength.

Timing of irradiation:

Using the above inks, in addition to heating the ink to a specific temperature, it is also possible to start the irradiation of the ejected ink after a time lag from landing to irradiation of 0.01 seconds to 0.5 seconds, more preferably after a time lag of 0.01 seconds to 0.3 seconds, and still more preferably after a time lag of 0.01 seconds to 0.15 seconds. In this manner, by controlling severely the time interval from ink landing to irradiation, it becomes possible to prevent the landed ink from bleeding before it gets hardened. In addition, even in the case of a porous recording medium, since it is possible to expose the ink to radiation before the ink penetrates into deep locations which cannot be reached by the radiation, it is possible to suppress-the residue of monomers that have not reacted yet thereby reducing the odor. This yields a big compound effect when high viscosity inks. In particular, it is possible to obtain a large combined effect by using inks with an ink viscosity at 25° C. of 35 to 500 mPa.s. By adopting such a recording method, even for different types of recording media whose surface wetness varies widely, it will be possible to maintain constant the diameter of the dot of ink that has landed on the recording medium, thereby improving the image quality. In addition, in order to obtain a color image, it is preferable to eject the inks in the order of the brightness of the ink starting from the ink with the lowest brightness. If a lower brightness ink is landed on a brighter ink, it will be difficult for the radiation to reach the inks in the lower regions, thereby obstructing the hardening sensitivity, resulting in increased residual monomers and consequent generation of odor, and greater probability of occurrence of deterioration in the adhesion characteristics. In addition, although it is possible to irradiate after all the inks have been ejected, it is desirable from the point of view of promoting hardening of the ink to expose the ink to radiation after each ink has been ejected.

Furthermore, in an ink jet head unit comprising heads of several colors, it is desirable in effect to have transparency to radiation in between the colors. In concrete terms, either no member is placed between two heads or the parts between heads are made of material that is transparent to the radiation being used. It is desirable to adopt such a simple construction as this, because by adopting this construction it becomes possible to irradiate the ink quickly and immediately after each color has been ejected, and, in particular, it becomes possible to prevent bleeding of secondary colors, and, in bidirectional printing, to prevent the difference in dot bleeding in the forward and reverse head traversal directions.

Ink Heating, Head Temperature Control:

It is desirable from the point of view of ink ejection stability that said inks are heated to a temperature in the range 30° C. to 150° C. and to carry out ink ejection after lowering the ink viscosity. It is more desirable to heat the inks to a temperature in the range of 40° C. to 100° C. Ink ejection becomes difficult at temperatures lower than 30° C. and higher than 150° C. Since inks of the radiation hardening type have, in general, higher viscosities than water based inks, their range of viscosity change due to temperature change is large. Since changes in the viscosity have large direct effects on the droplet size and droplet ejection speed and cause image quality deterioration, it is necessary to maintain the ink temperature as constant as possible. The control width of ink temperature should be ±5° C., and preferably be ±2° C., and still more preferably be ±1° C. Although ink temperature stabilization means are provided in an ink jet printer, the parts that are to be maintained at constant temperature are all the piping and other members from the ink tank (the intermediate ink tanks if intermediate ink tanks have been provided) up to the nozzle ejection plane.

For carrying out temperature control, it is desirable that plural temperature sensors are installed in each member of the piping, and that heating control is carried out according to the ink flow rate and the ambient temperature. In addition, the head unit that is heated under this temperature control should be thermally isolated or thermally insulated so that it is not affected from the chassis of the apparatus or from the ambient atmosphere. In order to reduce the printer warm-up duration that is required for heating the head unit at the time the power to the printer is switched ON, and also to decrease the loss of heat energy, it is desirable that not only the head unit is thermally insulated from other parts but also that the thermal capacity of the entire heating unit be made small.

Recording medium having no ink absorption capacity:

As a preferred embodiment of the present invention, it is possible to use a recording medium having no ink absorption capacity or a recording medium having low ink absorption capacity (or, a recording medium that does not absorb ink). A recording medium having no ink absorption capacity or a recording medium having low ink absorption capacity (or, a recording medium that does not absorb ink) is a recording medium that is made of a material having no ink absorption capacity or of a material having low ink absorption capacity (or, of a material that does not absorb ink), or is a recording material having a surface layer (image formation layer) that is made of a material having no ink absorption capacity or of a material having low ink absorption capacity (or, of a material that does not absorb ink), and the material having no ink absorption capacity or the material having low ink absorption capacity (or, the material that does not absorb ink) can, for example, be any plastic or metal.

Viscosity:

The inks used in the preferred embodiment of the present invention are liquids with a viscosity of 10 to 500 mPa.s at 30° C. It is desirable that the viscosity of the ink is in the range of 40 to 500 mPa.s. When the viscosity is lower than 10 mPa.s, the bleeding gets increased, and when the viscosity is higher than 500 mPa.s, the smoothness of image quality will be lost. In addition, it is desirable that these inks are liquids with a viscosity in the range of 3 to 30 mPa.s at 60° C., and still more desirably, the inks should have a viscosity of 3 to 30 mPa.s at that temperature. Abnormalities will occur in high speed ejection when the viscosity is lower than 3 mPa.s, and at viscosities higher than 30 mPa.s, the ejection characteristics get deteriorated.

1. An ink jet recording apparatus for expressing various colors by combinations of plural fundamental colors, the ink jet recording apparatus comprising:
a recording head for individually ejecting inks of plural fundamental colors;
a plurality of ink tanks for storing inks of two or more different densities for each of plural fundamental colors;
a pixel color component discrimination section that judges for each pixel whether the pixel is a single color component pixel having only one color component among the plural fundamental colors or multiple color component pixel having two or more color components among the fundamental colors; and
a recording head drive control section for selecting an ink to be ejected from the recording head among the inks of two or more different densities and for controlling a quantity of the ink ejected by the recording head, based on a judgment result of the pixel color component discrimination section, such that, for all or part of the multiple color component pixels, at least an ink of one color corresponding to one of color components of the multiple color component pixel and being landed on a multiple color component pixel has higher density and smaller quantity than an ink of said one color corresponding to a color component of a single color component pixel and being landed on the single color component pixel.

2. The ink jet recording apparatus of claim 1, further comprising:
a colorless surrounding pixel discrimination section for discriminating a colorless surrounding pixel, which is a pixel surrounding the multiple color component pixel and having no color component;
wherein the recording head drive control section, based on discriminating result of the colorless surrounding pixel discrimination section, with respect to one specific multiple color component pixel having the colorless surrounding pixel, controls not to land the ink corresponding to one of the color components of the multiple color component pixel or the inks corresponding to two or more but one less than a number of color components in the multiple color component pixel onto the one specific multiple color component pixel, but controls to land the ink or the inks, by each one color component, onto the colorless surrounding pixel.

3. The ink jet recording apparatus of claim 2, wherein colorless surrounding pixel discrimination section judges whether or not each of pixels in a series of pixels including two or more pixels, which are adjacent to one of the multiple color component pixel and are arranged in a direction going away from said one of the multiple color component pixel, is a colorless surrounding pixel of said one multiple color component pixel, and when all pixels in the series of pixels are judged to be the colorless surrounding pixel, the recording head drive control section selects, the furthest pixel in the series of pixels from said one multiple color component pixel as the colorless surrounding pixel onto which ink being landed.

4. The ink jet recording apparatus of claim 2, wherein the recording head drive control section, controls not to land the inks corresponding to a number of colors one less than a number of color components in one of the multiple color component pixel having the colorless surrounding pixel onto said one of the multiple color component pixel, but controls to land the inks, by each color component, onto the colorless surrounding pixel.

5. The ink jet recording apparatus of claims 1, further comprising an irradiation device for irradiating the ink landed on the recording medium with an energy ray, wherein the ink has a characteristic of being hardened by an irradiation of the energy ray.

6. The ink jet recording apparatus of claims 2, further comprising an irradiation device for irradiating the ink landed on the recording medium with an energy ray, wherein the ink has a characteristic of being hardened by an irradiation of the energy ray.

7. The ink jet recording apparatus of claims 3, further comprising an irradiation device for irradiating the ink landed on the recording medium with an energy ray, wherein the ink has a characteristic of being hardened by an irradiation of the energy ray.

8. The ink jet recording apparatus of claims 4, further comprising an irradiation device for irradiating the ink landed on the recording medium with an energy ray, wherein the ink has a characteristic of being hardened by an irradiation of the energy ray.

9. An ink jet recording method for expressing various colors by combinations of plural fundamental colors, by ejecting inks of plural fundamental colors with plural different densities from a recording head onto a recording medium, the ink jet recording method comprising:
judging, for each pixel, whether the pixel is a single color component pixel having only one color component among the plural fundamental colors or multiple color component pixel having two or more color components among the fundamental colors; and
selecting an ink to be ejected from the recording head among the inks with plural different densities and controlling a quantity of the ink ejected by the recording head, based on a result of the judging step, such that, for all or part of the multiple color component pixels, at least an ink of one color corresponding to one of color components of the multiple color component pixel and being landed on a multiple color component pixel has higher density and smaller quantity than an ink of said one color corresponding to a color component of a single color component pixel and being landed on the single color component pixel.

10. The ink jet recording method of claim 9, further comprising the steps of:
discriminating a colorless surrounding pixel, which is a pixel surrounding the multiple color component pixel and having no color component; and
controlling the recording head, based on the discriminating step of the colorless surrounding pixel, with respect to one specific multiple color component pixel having the colorless surrounding pixel, not to land the ink corresponding to one of the color components of the multiple color component pixel or the inks corresponding to two or more but one less than a number of color components in the multiple color component pixel onto the one specific multiple color component pixel, but to land the ink or the inks, by each one color component, onto the colorless surrounding pixel.

11. The ink jet recording method of claim 10, further comprising the steps of:
judging whether or not each of pixels in a series of pixels including two or more pixels, which are adjacent to one of the multiple color component pixel and are arranged in a direction going away from said one of the multiple color component pixel, is a colorless'surrounding pixel of said one multiple color component pixel; and
selecting, when all pixels in the series of pixels are judged to be the colorless surrounding pixel, the furthest pixel-in the series of pixels from said one multiple color component pixel as the colorless surrounding pixel onto which ink being landed.

12. The ink jet recording method of claim 10, further comprising the step of controlling not to land the inks corresponding to a number of colors one less than a number of color components in one of the multiple color component pixel having the colorless surrounding pixel onto said one of the multiple color component pixel, but to land the inks, by each color component, onto the colorless surrounding pixel.

13. The ink jet recording apparatus of claims 9, further comprising the step of irradiating the ink landed on the recording medium with an energy ray, wherein the ink has a characteristic of being hardened by an irradiation of the energy ray.

14. The ink jet recording apparatus of claims 10, further comprising the step of irradiating the ink landed on the recording medium with an energy ray, wherein the ink has a characteristic of being hardened by an irradiation of the energy ray.

15. The ink jet recording apparatus of claims 11, further comprising the step of irradiating the ink landed on the recording medium with an energy ray, wherein the ink has a characteristic of being hardened by an irradiation of the energy ray.

16. The ink jet recording apparatus of claims 12, further comprising the step of irradiating the ink landed on the recording medium with an energy ray, wherein the ink has a characteristic of being hardened by an irradiation of the energy ray.
